(19) United States
(12) Patent Application Publication
(10) Pub. No.: US 2005/0224241 A1
(43) Pub. Date: Oct. 13, 2005

(54) Force-control method for dual coil electric beating device

(76) Inventor: Chang-Ching Huang, Taichung (TW)

Correspondence Address: Chang-Ching Huang;235 Chung-Ho, Box 8-24, Taipei, TW

(21) Appl. No.: 10/822,293

(22) Filed: Apr. 12, 2004

(51) Int. Cl. B25D 1/00

(52) U.S. Cl. 173/1; 227/131

(57) ABSTRACT

A force-control method for a dual coil electric beating device is disclosed. The device has a single chip; an elastomer connected to an impact rod; and two coils for driving the impact rod as at least one of two coils are induced. The method comprises the steps of: programming the single chip to control conduction time periods of the two coils; actuating at least one of the two coils to deform the elastomer according to the programming in the single chip; de-actuating the actuating coils so as to restore the elastomer to displace the impact rod. The movement of the impact rod is controlled by the conduction time periods of the two coils which are determined by the programming in the single chip.

### FIELD OF THE INVENTION

The present invention relates to a force-control method for a dual coil electric beating device having a single chip and two coils for driving an impact rod to displace as at least one of two coils is induced, comprising the steps of: programming the single chip to control conduction time periods of the two coils so as to control the displacement of the impact rod.

### BACKGROUND OF THE INVENTION

In one prior art about electric beating device, a single coil is used to drive an impact rod as the coil is induced to generate magnetic field. The coil is confined to conduct at one half period of an AC cycle since in the other half cycle, the polarity will reverse. However this prior art will reduce impact force.

In one improvement device, two coils are used. An RC shift circuit with variable resistors is used to control a conduction time period of a first coil by adjusting the resistance of the resistor. Thereby the impact rod has different beating force.

However this kind prior art has the following disadvantages. The relation of the resistance with respect to the beating force of the impact rod is nonlinear. Thereby it can not be precisely controlled. No safety device is installed in the prior art so that if a mistake occurs, the impact rod will be triggered so as to hurt other people or objects possibly. Moreover, no over current protection to the circuit so that it is possible to destroy the circuit.

### SUMMARY OF THE INVENTION

Accordingly, the primary object of the present invention is to provide a force-control method for a dual coil electric beating device. The device has a single chip; an elastomer connected to an impact rod; and two coils for driving the impact rod as at least one of two coils are induced. The method comprises the steps of: programming the single chip to control conduction time periods of the two coils; actuating at least one of the two coils to deform the elastomer according to the programming in the single chip; de-actuating the actuating coils so as to restore the elastomer to displace the impact rod. The movement of the impact rod is controlled by the conduction time periods of the two coils which are determined by the programming in the single chip.

The various objects and advantages of the present invention will be more readily understood from the following detailed description when read in conjunction with the appended drawing.

### BRIEF DESCRIPTION OF THE DRAWINGS

FIG. 1 is a circuit about the force-control method for a dual coil electric beating device according to the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

The present invention relates to a force-control method for a dual coil electric beating device, in that one end of an impact rod (not shown) is connected to an elastomer (not shown). When the impact rod moves, the elastomer will deform so as to store elastic potential. When the movement of the impact rod is stopped, the potential will be released so as to accelerate the impact rod to generate a large beating force. In the moving path of the impact rod, a first coil and a second coil are arranged. When the coils are conducted, a magnetic field is generated to provide a pushing force to the impact rod. Above mentioned is technology of the prior art and thus the details will not be further described herein.

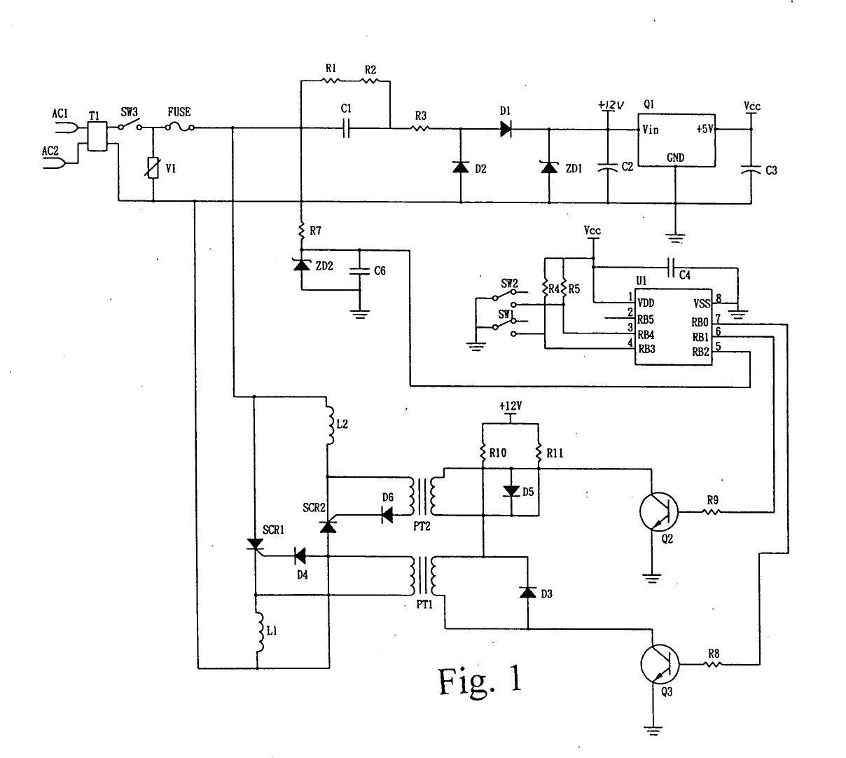

Referring to FIG. 1, the circuit diagram about the force-control method for a dual coil electric beating device according to the present invention is illustrated. AC power is inputted from the ends AC1 and AC2. A fuse FUSE is installed at an input end of the AC1 for avoiding over current to damage the elements of the circuit. A three terminal regulator Q1, a single chip U1, resistors, capacitors, and diodes serve to provide DC current Vcc to the circuit.

The present invention includes a safety switch SW2 and a trigger switch SW1. When the safety switch SW2 is actuated. The Vcc is connected to a third pin of the single chip U1. When the trigger switch SW1 is actuated, the Vcc is connected to the fourth pin of the single chip U1. When the safety switch SW2 and the trigger switch SW1 are actuated sequentially, trigger signals will be outputted from the sixth and seventh pins of the single chip U1. Then SRC1 and SRC2 will be triggered. Then the SRC1 is triggered, the first coil L1 will be conducted with the AC current. When the SRC2 is triggered, the second coil L2 will be conducted with the AC current. Thus, the first coil L1 is conducted firstly so as to generate a magnetic field to absorb the impact rod to move toward the second coil L2. When the second coil L2 is conducted, the impact rod will displace further so that the elastomer connected to the impact rod has a larger deformation to store more elastic potential energy. When the first coil L1 and second coil L2 are stopped, the magnetic fields disappear. The impact rod will not affect by magnetic force. The elastic potential energy of the elastomer will be released to be converted into dynamic energy to accelerate the impact rod. Thereby the impact rod is triggered. When it is desired to further trigger the impact rod, the safety switch SW2 and the trigger switch SW1 are de-actuated. Then the safety switch SW2 and the trigger switch SW1 are actuated sequentially. Thereby the single chip U1 will emit trigger signals to the SRC1 and SRC2 so as to perform the trigger action. Thereby the user will not be hurt due to a mistake after the first trigger.

The beating force of the impact rod is dependent to the deformation of the elastomer. The impact rod displaces by the magnetic fields of the first coil L1 and second coil L2. The conduction time periods of the first coil L1 and second coil L2 will determine the displacement of the impact rod. In the present invention, the single chip U1 is programmable so as to control the conduction time periods of the first coil L1 and the second coil L2 so as to generate different beating forces. Thus, by the present invention, the beating force can be controlled precisely.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A force-control method for a dual coil electric beating device having a single chip and two coils for driving an impact rod to displace as at least one of two coils are induced, comprising the steps of:
programming the single chip to control conduction time periods of the two coils so as to control the displacement of the impact rod.

2. The force-control method for a dual coil electric beating device as claimed in 1, wherein two coils are actuated at different timing.

3. The force-control method for a dual coil electric beating device as claimed in 1, wherein each coil is connected to a switch as a safety switch so as to provide a safety function.

4. A force-control method for a dual coil electric beating device having a single chip; an elastomer connected to an impact rod; and two coils for driving the impact rod as at least one of two coils are induced, comprising the steps of:
programming the single chip to control conduction time periods of the two coils;
actuating at least one of the two coils to deform the elastomer according to the programming in the single chip;
de-actuating the actuating coils so as to restore the elastomer to displace the impact rod;
wherein the movement of the impact rod is controlled by the conduction time periods of the two coils which are determined by the programming of the single chip.

3. The force-control method for a dual coil electric beating device as claimed in 1, wherein each coil is connected to a switch as a safety switch so as to provide a safety function.
